(19) United States
(12) Patent Application Publication
(10) Pub. No.: US 2026/0205692 A1
(43) Pub. Date: Jul. 16, 2026

(54) IMAGE CAPTURING APPARATUS THAT PERFORMS LIGHT MODULATION CONTROL WHILE FOLLOWING OBJECT, METHOD OF CONTROLLING SAME, AND STORAGE MEDIUM

(71) Applicant: CANON KABUSHIKI KAISHA, Tokyo (JP)

(72) Inventors: TAKAAKI AKIYAMA, Kanagawa (JP); JUNJI TAKAI, Kanagawa (JP); NOBUKAZU YOSHIDA, Kanagawa (JP)

(21) Appl. No.: 19/440,991

(22) Filed: Jan. 6, 2026

(30) Foreign Application Priority Data
Jan. 14, 2025 (JP) 2025-004685

(51) Int. Cl. H04N 23/68; H04N 23/56; H04N 23/61

(52) U.S. Cl. CPC H04N 23/6811; H04N 23/56; H04N 23/61

(57) ABSTRACT

An image capturing apparatus that performs continuous photographing with light emission from a light emitting device. A light emission amount calculation unit determines a light emission amount for a first frame of still images acquired by the continuous photographing by performing preliminary light emission. An object detection unit detects an object from an image. An object moving distance prediction unit predicts a moving distance of the object from a time point when a past frame out of the still images by the continuous photographing was photographed to a time point when the next frame is to be photographed based on a detection result. The light emission amount calculation unit determines a light emission amount for photographing of the next frame based on the predicted moving distance of the object, and a light emission amount used at the time point when the past frame has been photographed.

### BACKGROUND

### Field of the Technology

The present disclosure relates to an image capturing apparatus that performs light modulation control while following an object, a method of controlling the image capturing apparatus, and a storage medium, and particularly to an image capturing apparatus that performs continuous photographing using light emission of a light emitting device, a method of controlling the image capturing apparatus, and a storage medium.

### Description of the Related Art

To photograph in a dark place, a light emitting device is conventionally used to illuminate an object and its background.

A light emitting device is known which is incorporated in a camera or is connected physically or by wireless to a camera, for control.

In general, as this light emitting device, there are known, for still image photographing, a device using strobe light emission, and for moving image photographing, a device using a video light.

In the still image photographing with strobe light emission, as a method of determining a strobe light emission amount of main light emission, there is known a method of determining, by performing preliminary light emission for emitting light with a suppressed strobe light emission amount immediately before main light emission, a light emission amount necessary for the main light emission based on an amount of light reflected from an object when the preliminary light emission is performed, and the like.

This method using preliminary light emission is high in accuracy, but an energy loss caused by preliminary light emission affects the number of images which can be photographed with strobe light emission.

Particularly, in continuous photographing with strobe light emission, if preliminary light emission is performed whenever each frame is photographed, the speed of continuous photographing is reduced, or the number of images which can be photographed is reduced.

To prevent this, there is known a technique for performing, in continuous photographing with strobe light emission, light modulation control while following an object without performing preliminary light emission in photographing of each frame.

Japanese Laid-Open Patent Publication (Kokai) No. 2008-152097 discloses a technique that detects, in continuous photographing with strobe light emission, a change in distance to an object by measuring an amount of reflected light in an illuminated image obtained by photographing each frame, and adjusts a light emission amount for the next frame.

However, in the technique described in Japanese Laid-Open Patent Publication (Kokai) No. 2008-152097, to adjust the light emission amount for the next frame with high accuracy, it is necessary to measure amounts of reflected light in illuminated images obtained by photographing a plurality of frames before photographing the next frame, and as for several images from the start of continuous photographing, it is difficult to properly adjust the strobe light emission amount.

### SUMMARY

The present disclosure is directed to providing an image capturing apparatus that is capable of performing light modulation control while following an object with high accuracy without performing preliminary light emission in photographing of each frame immediately after the start of continuous photographing with light emission from a light emitting device, a method of controlling the image capturing apparatus, and a storage medium.

In a first aspect of the present disclosure, there is provided an image capturing apparatus that determines a light emission amount of a light emitting device, and acquires still images by performing continuous photographing with light emission from the light emitting device, including at least one processor, and a memory storing instructions that, when executed by the at least one processor, causes the at least one processor to function as a first light emission amount determination unit configured to determine a light emission amount for a first frame of still images that are acquired by the continuous photographing by performing preliminary light emission, a detection unit configured to detect an object from an image, a prediction unit configured to predict a moving distance of the object from a time point when a past frame out of the still images that are acquired by the continuous photographing was photographed to a time point when the next frame is to be photographed, based on a detection result obtained by the detection unit, and a second light emission amount determination unit configured to determine a light emission amount for photographing of the next frame, based on the moving distance of the object, predicted by the prediction unit, and a light emission amount used at the time point when the past frame was photographed.

In a second aspect of the present disclosure, there is provided a method of controlling an image capturing apparatus that determines a light emission amount of a light emitting device, and performs continuous photographing of still images with light emission from the light emitting device, including determining a light emission amount for a first frame of still images acquired by the continuous photographing by performing preliminary light emission, detecting an object from an image, predicting a moving distance of the object from a time point when a past frame out of the still images that are acquired by the continuous photographing was photographed to a time point when the next frame is to be photographed, based on a detection result obtained by the detecting, and determining a light emission amount for photographing of the next frame, based on the moving distance of the object, predicted by the predicting, and a light emission amount used at the time point when the past frame was photographed.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing a hardware configuration of an image capturing apparatus according to a first embodiment.

FIG. 2 is a flowchart of a control process for continuous photographing without preliminary light emission in the first embodiment.

FIG. 3A is a timing diagram useful in explaining control of continuous photographing without preliminary light emission in the first embodiment.

FIG. 3B is a diagram showing a relationship between an object detection result and a linear approximation formula in the first embodiment.

FIG. 3C is a diagram showing an object photographed at a time point t and an object detection result predicted for a time point of next photographing.

FIG. 4 is a flowchart of a control process for continuous photographing without preliminary light emission in a second embodiment.

FIGS. 5A and 5B are diagrams showing a method of determining an object luminance in the second embodiment.

FIG. 6 is a flowchart of a control process for continuous photographing without preliminary light emission in a third embodiment.

FIG. 7 is a timing diagram useful in explaining control of continuous photographing without preliminary light emission in a case where an object cannot be detected due to a low luminance of live view (LV) images in the third embodiment.

FIG. 8 is a timing diagram useful in explaining control of continuous photographing without preliminary light emission in a case where an object cannot be detected due to a high luminance of a still image in the third embodiment.

FIGS. 9A to 9D are diagrams useful in explaining an example of a state in which a plurality of objects are detected in a fourth embodiment.

FIG. 10 is a flowchart of a control process for continuous photographing without preliminary light emission in the fourth embodiment.

FIGS. 11A to 11C are diagrams each showing a table of various related information used in the fourth embodiment.

### DESCRIPTION OF THE EMBODIMENTS

The present disclosure will now be described in detail below with reference to the accompanying drawings showing embodiments thereof. The embodiments described below are not intended to limit the present disclosure. A plurality of features are described in the embodiments, but not all combinations of the features are absolutely essential to the solution of the present disclosure, and further, two or more desired components (features) of the embodiments can be combined. Further, in the accompanying drawings, the same or similar component is denoted by the same reference numeral, and redundant description is omitted.

A description will be given of a camera 1 as an image capturing apparatus according to a first embodiment, which is comprised of a camera body unit 100, and a lens unit 200 and a strobe device 300, which are attached to the camera body unit 100.

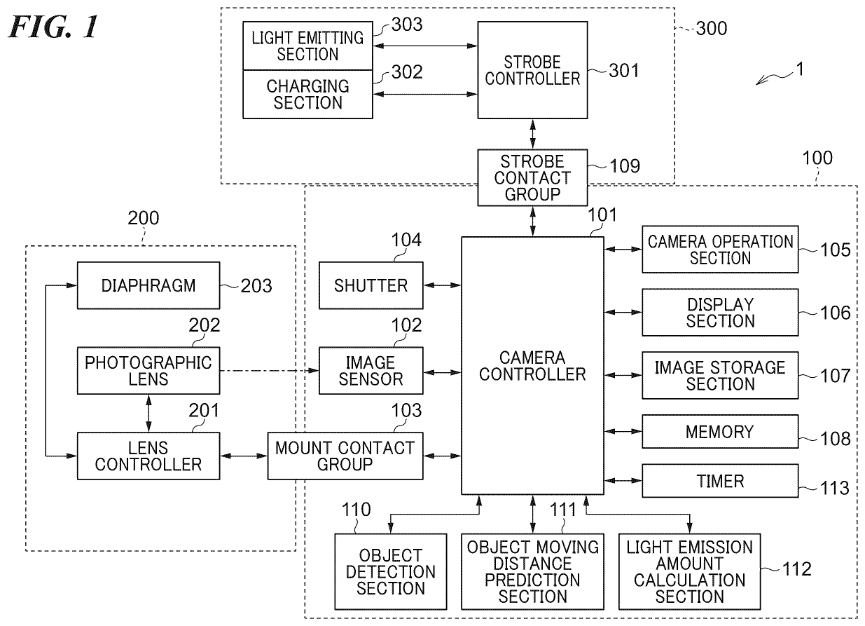

FIG. 1 is a block diagram showing a hardware configuration of the camera 1.

As shown in FIG. 1, the camera 1 is comprised of the camera body unit 100, the lens unit 200, and the strobe device 300 (light emitting device).

The lens unit 200 is attached to the front surface of the camera body unit 100.

The lens unit 200 is interchangeable, and the camera body unit 100 and the lens unit 200 are electrically connected via a mount contact group 103.

The strobe device 300 is attached to the top surface of the camera body unit 100.

The strobe device 300 is interchangeable, and the camera body unit 100 and the strobe device 300 are electrically connected via a strobe contact group 109.

The camera body unit 100 includes a camera controller 101, an image sensor 102, the mount contact group 103, a shutter 104, a camera operation unit 105, a display unit 106, an image storage unit 107, and a memory 108. Further, the camera body unit 100 includes the strobe contact group 109, an object detection unit 110, an object moving distance prediction unit 111, a light emission amount calculation unit 112, and a timer 113.

The lens unit 200 includes a lens controller 201, a photographic lens 202, and a diaphragm 203.

The strobe device 300 includes a strobe controller 301, a charging unit 302, and a light emitting unit 303.

The camera controller 101 is a microcomputer that controls operations of the components of the camera body unit 100 and is comprised of a central processing unit (CPU) 101a, a read only memory (ROM) 101b, and a random access memory (RAM) 101c (none of which are shown in FIG. 1).

The image sensor 102 converts light from an object, which is incident through the photographic lens 202, to electrical signals to generate image data, and outputs the generated image data to the camera controller 101. The camera controller 101 controls a signal (vertical synchronization signal) for operating the image sensor 102, and can control accumulation of electric charges in the image sensor 102 by controlling timing of resetting electric charges accumulated in the image sensor 102.

The shutter 104 is formed by a front curtain and a rear curtain, and when the front curtain runs to open the shutter 104 to thereby start exposure to the image sensor 102, and when the rear curtain runs to close the shutter 104 to terminate the exposure to the image sensor 102.

The camera operation unit 105 includes operation members which are disposed on the camera body unit 100 and can be operated by a user, such as a button, a switch, a dial, and a connection device, detects an operation performed by a user on the camera operation unit 105, and sends a signal according to an operation instruction to the camera controller 101. For example, the camera operation unit 105 outputs a SW1 signal to the camera controller 101 in a case where a user performs a half-pressing operation, i.e. an operation of half pressing a release button, and outputs a SW2 signal to the camera controller 101 in a case where the user performs a fully-pressing operation, i.e. an operation of deeply pushing the release button.

The display unit 106 is capable of displaying photographing information, displaying a live view (hereinafter referred to as LV) image, displaying a photographed still image, and so forth, according to an instruction from the camera controller 101. The display of an LV image is realized by continuously performing charge accumulation (image capturing) using the image sensor 102 and sequentially displaying a plurality of acquired image data.

The camera controller 101 controls the operation of the camera body unit 100 based on a signal output from the camera operation unit 105.

In a case where the signal output from the camera operation unit 105 is a SW1 signal, the camera controller 101 performs detection of a face or the like of an object and discrimination of the object (such as a human and an animal) from a LV image capturing result, and repeats photometry control for measuring a luminance of an object. The camera controller 101 performs not only the photometry control but also determines a shutter speed, an aperture value, and an ISO sensitivity, which are to be used when photographing is performed, from photometric results. Here, the shutter speed, the aperture value, and the ISO sensitivity, which are used when photographing is performed, are collectively referred to as the exposure control values. The determined exposure control values are displayed on a screen of the display unit 106.

In a case where a signal output from the camera operation unit 105 is a SW2 signal, the camera controller 101 drives the diaphragm 203 in the photographic lens 202, sets a sensitivity (ISO sensitivity) of the image sensor 102, and controls the shutter 104 to allow light to enter the image sensor 102. The camera controller 101 performs control to display a photographed image on the screen of the display unit 106 according to image data acquired from the image sensor 102 and write the image data into the image storage unit 107.

In a case where a user is continuously performing the fully pressing operation, the camera controller 101 starts continuous photographing. After that, the camera controller 101 performs the above-described photometry control and exposure control based on LV images obtained between operations of photographing a still image and a photographing result of the still image to repeat photographing until the fully pressing operation is released.

The memory 108 is a RAM and records various kinds of data associated with the photographing operation executed by the camera controller 101.

The object detection unit 110 detects an object in an image and outputs information on the detected object. The information on the object includes information on an object ID, a type, a size, and an orientation of the object, reliability, and the like, and it is possible to employ a known method, such as a method using an algorithm for extracting an object area by deep learning, for detection of an object. In a case where one object is detected a plurality of times, the object detection unit 110 can recognize this object as the identical object, and the same ID is assigned to the identical object. By analyzing changes in detection results of the same ID, it is also possible to observe movement of a specific object. Further, as an image from which an object is detected, an image obtained by still image photographing or each LV image output from the image sensor 102 using a vertical synchronization signal as a trigger is used.

The timer 113 is a measurement unit that measures a time at which an object is detected, an object detection interval, the latest time, and so forth.

The object moving distance prediction unit 111 predicts a moving distance of an object between time points using time-series-based object detection results. In the present embodiment, a description will be given of a method of predicting a moving distance of the object based on an amount of change in size by using a size of a face frame as a detection result of an object However, the object detection result is not limited to the size of the face frame, but information expressing a size of an object can be used. Further, an absolute distance to an object, which is measured by using a known method of measuring a distance from the camera 1 to the object, can be used.

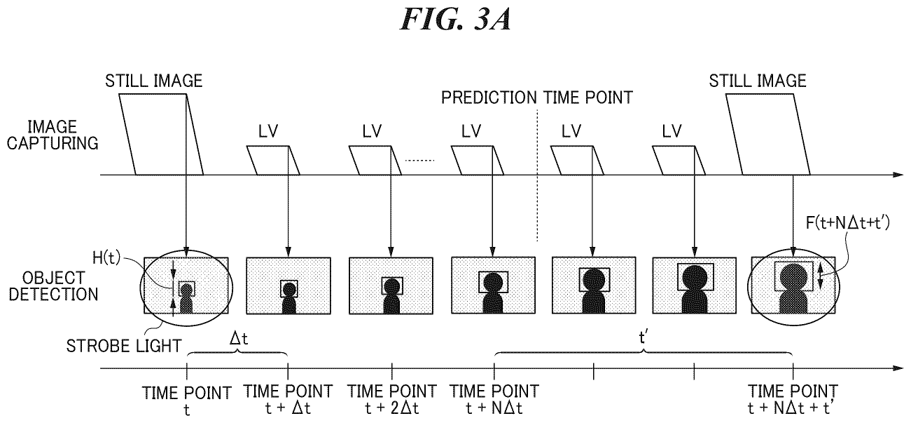

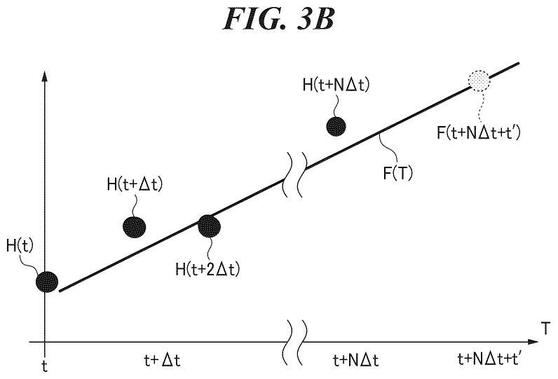

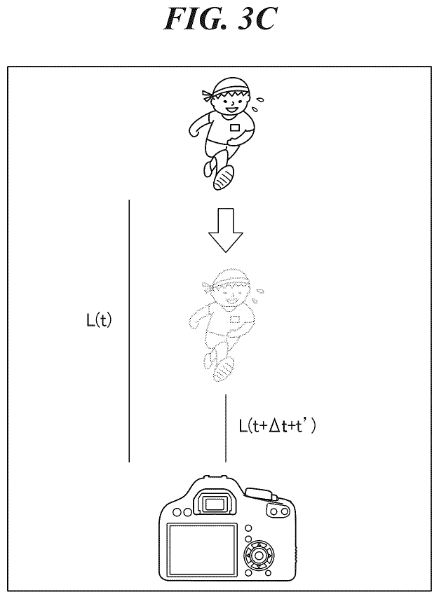

The method of predicting a moving distance of an object between certain time points, according to the present embodiment, which is used by the object moving distance prediction unit 111, will be described below with reference to FIGS. 3A and 3B.

FIG. 3A is a timing diagram useful in explaining control of continuous photographing without preliminary light emission in the present embodiment.

The timing diagram shown in FIG. 3A shows object detection timings of a still image and LV images. While H(t) expresses a vertical length of a face frame as a result of detection of an object, an image of which is captured at a time point t, the number of LV images output in a time period from the time point t to a prediction time point is expressed by N, and an output interval of the LV images is expressed by Δt. In this case, the object moving distance prediction unit 111, first, reads out time points t, t+Δt, t+2Δt, . . . , and t+NΔt, and object detection results H(t), H(t+Δt), H(t+2Δt), . . . , and H(t+NΔt), obtained at the respective time points, which have been stored in the memory 108. Next, the object moving distance prediction unit 111 predicts a moving distance of the object until the next photographing time point (t+NΔt+t′), by using the time points and the detection results, which are read out from the memory 108, and a time period t′ from the time point t+NΔt to the next still image photographing.

Next, a linear approximation formula for predicting a detection result of an object at the next photographing time point (t+NΔt+t′) will be described with reference to FIG. 3B.

First, a linear approximation formula F (T) for calculating the vertical size of a face frame is determined based on the object detection results H(t) to H(t+NΔt) formed by a discrete data group. Next, F(t+NΔt+t′) obtained by substituting the time point t+NΔt+t′ into the obtained linear approximation formula F(T) is set as the object detection result predicted at the next photographing time point.

Thereafter, when a ratio of the vertical size of the face frame at the time point t+NΔt+t′ to the vertical size of the face frame at the time point t is expressed by R, R is calculated by the following equation (1):

$$R = F ( t + N Δ t + t ’ ) / H ( t ) \qquad ( 1 )$$

The value of R is equal to L(t+NΔt+t′)/L(t) assuming that a distance between the object and the camera 1 at the time point t, shown in FIG. 3C, is expressed by L(t), and a distance between the object and the camera 1 at the time point t+NΔt+t', shown in FIG. 3C, is expressed by L(t+NΔt+t′). The value R calculated here is set as the prediction result.

Referring again to FIG. 1, the light emission amount calculation unit 112 calculates a light emission amount at the photographing time, which is to be instructed to the strobe device 300 such that still image photographing results in a proper brightness. The light emission amount calculated here is calculated by using the distance between the camera 1 and the object and the exposure set value of the camera 1.

In a case where the light emission amount calculation unit 112 calculates the light emission amount by performing preliminary light emission, the light emission amount is calculated by using a known method. For example, there can be employed a method of determining a necessary light emission amount by measuring a distance to an object by determining a difference between an image captured with preliminary light emission before photographing and an image captured without preliminary light emission.

Further, the light emission amount calculation unit 112 can use a method of calculating a light emission amount by using a moving distance of an object, which is predicted by the object moving distance prediction unit 111.

In a case where a light emission amount used when the immediately preceding frame was photographed is expressed by G1, a predicted light emission amount to be used when the next frame is photographed is expressed by G2, and a result predicted by the object moving distance prediction unit 111 is expressed by R, to make the amount of strobe light reaching the object in the immediately preceding frame and the amount of strobe light reaching in the next frame equal to each other, it is necessary to change the light emission amount proportionally to the second power of R. To this end, the change is expressed by the following APEX relational expression (2):

$$G 2 = G 1 + 2 * Log ( R ) \qquad ( 2 )$$

Next, the configuration of the lens unit 200 will be described with reference to FIG. 1.

The lens controller 201 is a microcomputer that controls operations of the components of the lens unit 200.

The photographic lens 202 is formed by a plurality of lenses to form an object image on the image sensor 102. Further, in the photographic lens 202, the diaphragm 203 for adjusting an amount of light and a focus lens (not shown) for adjusting the focus are provided.

The lens controller 201 adjusts an amount of light taken into the camera 1 and the focus according to an instruction transmitted from the camera controller 101 via the mount contact group 103.

Further, the lens controller 201 reads a position of the focus lens, converts the read position to an object distance, and outputs the object distance to the camera controller 101.

Next, the configuration of the strobe device 300 will be described with reference to FIG. 1.

The strobe controller 301 is a microcomputer that controls operations of the components of the strobe device 300. The strobe controller 301 can communicate with the camera controller 101 via the strobe contact group 109 and is capable of receiving a light emission control instruction and camera information from the camera 1, and transmitting strobe information.

The charging unit 302 charges a capacitor for light emission, not shown, with energy for generating illumination light to illuminate an object to be photographed, by using electric power of a battery, not shown, mounted on the strobe device 300. The charging operation is controlled by the strobe controller 301, and the strobe controller 301 detects a voltage charged in the capacitor for light emission and controls the charging unit 302 to stop the charging operation when the voltage reaches a predetermined voltage threshold value or more (charging completion). Further, when the voltage becomes lower than the predetermined voltage threshold value, the strobe controller 301 controls the charging unit 302 to start the charging operation. The charged voltage and charging completion flag information are transmitted to the camera controller 101 via the strobe contact group 109.

The light emitting unit 303 drives, according to an instruction from the strobe controller 301, a light emission circuit, not shown, to emit strobe light by releasing energy charged in the capacitor for light emission to a discharge tube of the light emission circuit, and illuminates the object via a light emission optical system, not shown.

The strobe controller 301 can acquire light emission timing and the light emission amount from the camera controller 101 via the strobe contact group 109. With this, the camera controller 101 can cause the light emitting unit 303 to emit a predetermined amount of light at a predetermined timing.

In a case where an object is dark, or in a case where the camera setting is set to strobe photographing by a user, the camera controller 101 starts photographing using the strobe device 300 with preliminary light emission setting. This preliminary light emission setting refers to a setting for emitting light from the light emitting unit 303 immediately before photographing so as to perform light modulation calculation for calculating a light emission amount to be set when photographing is performed, and performing light modulation calculation for determining a light emission amount to be set when light is emitted at the photographing time based on an image captured with preliminary light emission and an image captured without preliminary light emission. Hereafter, in strobe photographing, light emission of the light emitting unit 303 immediately before photographing is referred to as the preliminary light emission, and light emission at the photographing time is referred to as the main light emission.

The user can make a variety of settings of a shutter speed, an aperture value, an ISO sensitivity, presence/absence of flicker and so forth at the photographing time, including a setting of strobe photographing for causing the light emitting unit 303 of the strobe device 300 to emit light.

As this strobe photographing setting, the user can also make a setting in which preliminary light emission is not performed during continuous photographing (hereinafter referred to as the “non-preliminary light emission setting”).

Note that the initial setting in the present embodiment is made such that, in the strobe photographing, preliminary light emission is performed during continuous photographing. In this setting, a light emission amount of main light emission for each frame during continuous photographing is calculated by using an amount of reflected light of preliminary light emission performed immediately before photographing of each frame, and strobe light emission from the light emitting unit 303 is controlled based on a result of the calculation.

On the other hand, when the user makes the above-mentioned non-preliminary light emission setting as the strobe photographing setting, which is the setting in which preliminary light emission is not performed during continuous photographing, the light emission amount of main light emission for each frame during continuous photographing is calculated by using e.g. a result of object detection without performing preliminary light emission. With this, it is possible to prevent reduction of a frame photographing speed and reduction of the number of images which can be photographed during continuous photographing using strobe light emission. Note that in the non-preliminary light emission setting, further, the user can also make an additional preliminary light emission setting for performing preliminary light emission immediately before the next frame when the continuous photographing time reaches a predetermined time during continuous photographing. With this, even in a case where darkness of an object changes during a long continuous photographing time, it is also possible to properly adjust the light emission amount of main light emission.

The following description will be given of a case where the user makes the non-preliminary light emission setting in the camera 1 comprised of the camera body unit 100, the lens unit 200, and the strobe device 300. That is, the description will be given of a control process for continuous photographing without preliminary light emission according to the present embodiment, for controlling light without performing preliminary light emission between frames when a moving object is continuously photographed with strobe light emission.

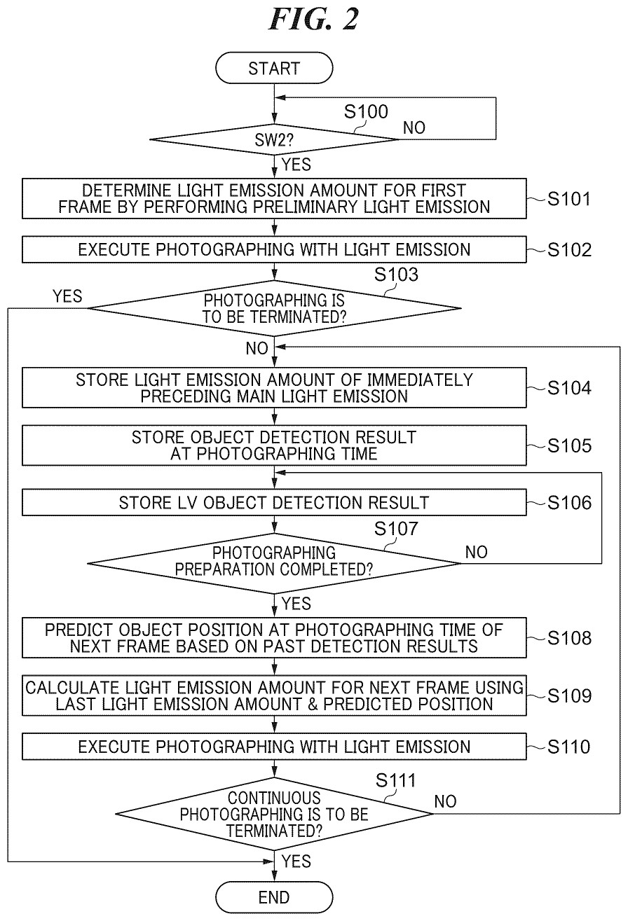

FIG. 2 is a flowchart of the control process for continuous photographing without preliminary light emission in the present embodiment.

In the present process, in continuous photographing, a proper light emission amount is calculated by performing preliminary light emission when the first frame is photographed. On the other hand, when the second and subsequent frames are photographed, a proper light emission amount is determined without performing preliminary light emission, based on a light emission amount when the past frame was photographed and an object position predicted using a result of object detection for a time point when the next frame is to be photographed. Note that the past frame is desirable to be an immediately preceding frame but is not limited to this insofar as it is a past frame obtained during the continuous photographing.

Further, the present process is executed in the camera controller 101 by the CPU 101a that loads a program stored in the ROM 101b into the RAM 101c.

In a step S100, the camera controller 101 determines whether the current state of the SW2 is ON or OFF. If the current state of the SW2 is OFF, i.e. if the release button is not being fully pressed by the user (NO to the step S100), the determination in the step S100 is repeated. On the other hand, if the current state of the SW2 is ON, i.e. if the release button is being fully pressed by the user (YES to the step S100), the process proceeds to a step S101.

In the step S101, the camera controller 101 performs preliminary light emission using the strobe device 300 immediately before photographing the first frame and controls the light emission amount calculation unit 112 (first light emission amount determination unit) to calculate a proper light emission amount based on a preliminary illuminated image captured by the image sensor 102.

In a step S102, the camera controller 101 notifies the strobe device 300 of the light emission amount calculated by the light emission amount calculation unit 112 and the light emission timing via the strobe contact group 109 and causes the strobe controller 301 to perform main light emission simultaneously with photographing of the first frame.

In a step S103, the camera controller 101 determines whether to continue or terminate the photographing. Specifically, in a case where the current state of the SW2 has been changed from ON to OFF, i.e. in a case where the operation of fully pressing the release button has been released by the user, the camera controller 101 determines that the photographing is to be terminated. On the other hand, in a case where the current state of the SW2 has not been changed from ON, i.e. in a case where the operation of fully pressing the release button is continued by the user, the camera controller 101 determines that the photographing is to be continued.

If it is determined that the photographing is to be continued (NO to the step S103), the process proceeds to a step S104 to execute processing for photographing the next frame, whereas if it is determined that the photographing is to be terminated (YES to the step S103), the present process is terminated.

In the step S104, the camera controller 101 stores the light emission amount of the immediately preceding main light emission in the memory 108.

In a step S105, the camera controller 101 stores a result of object detection from the immediately preceding photographing result by the object detection unit 110 (detection unit) and a time at which the photographing has been performed, in the memory 108. In a case where, as a result of object detection, a face area has been detected as a frame, the size of the frame is stored. Here, the immediately preceding photographing result refers to a result of photographing of the first frame, which was performed in the step S102. However, in a case where it is determined in a step S111, described hereinafter, that the continuous photographing is to be continued, and the process proceeds to the step S104, the immediately preceding photographing result refers to a result of photographing of a frame photographed in a step S110, described hereinafter.

At this time, in a case where the focal length of the photographic lens 202 is changeable, and the focal length changes during continuous photographing, for example, even when a distance from the camera 1 to the object is constant, a result of object detection performed by the object detection unit 110 sometimes changes according to a change in the focal length. Although the size of the face frame is used as the result of object detection in the present embodiment, even when the object is not moving, if the focal length moves toward the tele side, the size of the face frame detected by the object detection unit 110 rapidly becomes large. In this case, there is a fear that the size of the face frame cannot be detected by the object detection unit 110 with high accuracy. To prevent this, in the present embodiment, the size of the face frame converted to a focal length used as a reference is stored. For example, the focal length as the reference can be set to a focal length of the first frame when the continuous photographing is started or set to a desired fixed value determined before photographing. With this, the object detection unit 110 can detect the size of the face frame with high accuracy without being affected by a change in the focal length.

In a step S106, the camera controller 101 (acquisition unit) controls the image sensor 102 to start capturing of LV images between frames using a vertical synchronization signal output after photographing a frame, as a trigger, and acquires the LV images. After that, for each captured LV image, the camera controller 101 records a result of detection of an object detected from the photographed result by using the object detection unit 110, and the LV image capturing time, in the memory 108, as the LV object detection result.

In a step S107, the camera controller 101 determines whether or not the photographing preparation is completed. Specifically, for example, in a case where the exposure control values of the camera 1 have been set, and, at the same time, the photographing setting for a timing of photographing the next frame based on the photographing interval setting of the continuous photographing is completed, it is determined that the photographing preparation is completed.

If it is determined that the photographing preparation is completed (YES to the step S107), the process proceeds to a step S108, whereas if it is determined that the photographing preparation is not completed yet (NO to the step S107), the process returns to the step S106.

In the step S108, the camera controller 101 controls the object moving distance prediction unit 111 (prediction unit) to predict a moving distance between the object and the camera 1 at a time point when the next frame is to be photographed by using the above-described method. After that, the camera controller 101 calculates a ratio (R) between the object distance at a time point when the immediately preceding frame was photographed and the predicted object distance at a time point when the next frame is to be photographed, and stores this ratio (R) in the memory 108 as the prediction result. In the step S108, a linear approximation formula is determined by the object moving distance prediction unit 111 employing a known method, such as the least squares method, using the object detection result stored in the memory 108 as described above with reference to FIG. 3B, and derives the prediction result R expressed by the equation (1). However, although in the example described with reference to FIGS. 3A to 3C, the approximation is performed by a linear function, to cope with a scene in which an object is not moving at a constant speed, as the linear approximation formula, the linear function is not limitedly used, but a desired polynomial expression can be used.

In a step S109, the camera controller 101 controls the light emission amount calculation unit 112 (second light emission amount determination unit) to calculate an optimum light emission amount for photographing of the next frame, which is to be stored in the memory 108, based on the prediction result calculated in the step S108 and the light emission amount used in the past photographing. Specifically, the predicted light emission amount (G2) is calculated by the above-mentioned equation (2) as the optimum light emission amount for photographing of the next frame.

In the step S110, the camera controller 101 notifies the strobe device 300 of the light emission amount calculated in the step S109 and the light emission timing via the strobe contact group 109 and causes the strobe controller 301 to perform main light emission simultaneously with photographing of the next frame.

In the step S111, the camera controller 101 determines whether to continue or terminate the continuous photographing. Specifically, in a case where the current state of the SW2 has been changed from ON to OFF, i.e. in a case where the operation of fully pressing the release button has been released by the user, the camera controller 101 determines that the continuous photographing is to be terminated. On the other hand, in a case where the current state of the SW2 has not been changed from ON, i.e. in a case where the operation of fully pressing the release button has been continued by the user, the camera controller 101 determines that the continuous photographing is to be continued.

If it is determined that the continuous photographing is to be continued (NO to the step S111), the step S104 et seq. are repeated. On the other hand, if it is determined that the continuous photographing is to be terminated (YES to the step S111), the present process is terminated.

With the above-described process, in a case where continuous photographing using strobe light emission is performed with the non-preliminary light emission setting, preliminary light emission is not performed between frames, and a moving distance of an object is predicted with high accuracy using a photographing result of an immediately preceding frame and a result of object detection from capturing results of LV images between the frames. With this, it is possible to perform photographing with a proper light emission amount from the second frame without performing preliminary light emission immediately before the photographing.

Next, a second embodiment will be described. Similar to the first embodiment, in the present embodiment, in a case where continuous photographing with strobe light emission is performed with the non-preliminary light emission setting, movement of an object between frames is predicted, and the light emission amount for photographing of the next frame is determined. However, in the present embodiment, the light emission amount for photographing of the next frame is further corrected by using the brightness of a photographing result obtained during continuous photographing.

In the first embodiment, the description has been given of the method of calculating the optimum light emission amount for the next frame by using the information on an object detected from capturing results of LV images between frames. However, the light emission amount determined by this method can slightly degrade accuracy e.g. in a case where a moving direction or speed of the object changes after the prediction time point indicated in FIG. 3A.

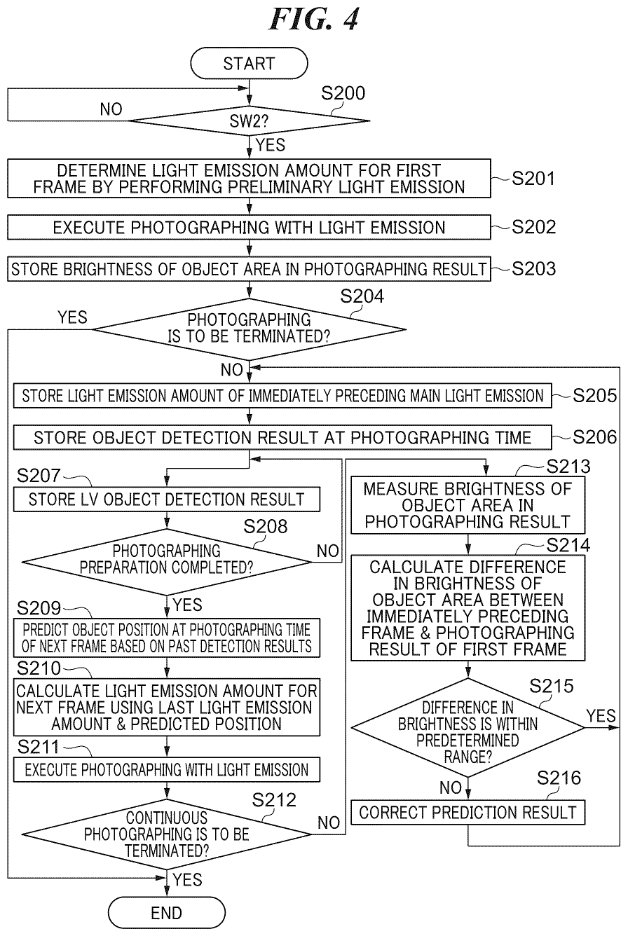

To cope with this, in the present embodiment, by correcting the prediction accuracy by using the brightness of an object in an image which has been actually photographed, even when a frame insufficient in prediction accuracy temporarily exists, light is emitted with proper brightness when a frame after photographing the frame insufficient in prediction accuracy. A control process for continuous photographing without preliminary light emission according to the present embodiment will be described in detail with reference to FIG. 4.

Note that in the present embodiment, the same hardware components and software components as those of the first embodiment are denoted by the same reference numerals, and redundant description is omitted.

FIG. 4 is a flowchart of the control process for continuous photographing without preliminary light emission in the present embodiment.

The present process is executed in the camera controller 101 by the CPU 101a that loads a program stored in the ROM 101b into the RAM 101c.

Note that steps S200 to S202 and steps S204 to S212 are the same processing operations as the steps S100 to S102 and the steps S103 to S111 of the first embodiment, respectively, and hence description thereof is omitted.

In the present embodiment, after execution of the steps S200 to S202, the camera controller 101 executes a step S203, described hereinafter, and then proceeds to the step S204. Further, if the answer to the question of the step S212 is negative (NO) (i.e. the continuous photographing is to be continued), the camera controller 101 does not directly return to the step S205 but executes steps S213 to S216 to correct the prediction result, and then returns to the step S205. The control process for continuous photographing without preliminary light emission in the present embodiment will be described in detail below.

First, in the steps S203 and S213, the camera controller 101 measures the brightness of the image as the photographing result of the immediately preceding photographed frame and stores the brightness in the memory 108. For the brightness of the image, for example, a luminance value of a masked area (hereinafter referred to as the “object luminance value”) can be used which is formed by masking an object area from the image by using a result of object detection in the step S209.

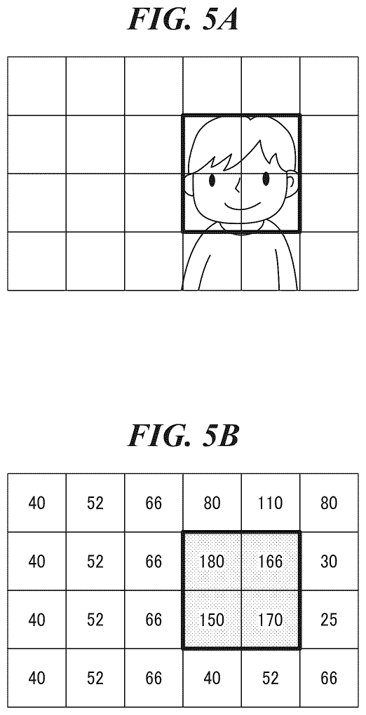

Here, a method of determining an object luminance value from an image using a detection result in the present embodiment will be described with reference to FIGS. 5A and 5B.

FIG. 5A shows an example of an image output from the image sensor 102, which is divided into blocks. Further, FIG. 5B shows an example of luminance values of the respective blocks. At this time, a detection result output from the object detection unit 110 includes information for identifying a block belonging to an object area. The object luminance value is calculated by calculating a weighted average of the luminance values of the blocks belonging to the object area.

Referring again to FIG. 4, when the process proceeds to the step S214 after execution of the step S213, the camera controller 101 calculates a difference between the brightness of the object area in the photographing result of the immediately preceding frame and the brightness of the object area in the photographing result of the first frame.

In the step S215, the camera controller 101 determines whether or not the difference in brightness, calculated in the step S214, is within a predetermined range (Th1 to Th2). If it is determined that the difference in brightness is within the predetermined range (YES to the step S215), it is determined that the immediately preceding prediction has been accurately performed (satisfies the predetermined accuracy), the correction processing is immediately terminated, and the step S205 et seq. are repeated. On the other hand, if it is determined that the difference in brightness is not within the predetermined range (NO to the step S215), it is determined that the immediately preceding prediction does not satisfy the predetermined accuracy, and the process proceeds to the step S216 to correct the prediction result.

In the step S216, the camera controller 101 corrects the prediction result determined in the step S209 before photographing the next frame. In the present embodiment, an example of the correction method in an environment with no external light will be described.

Y0 represents a luminance value in an object area in an image of the first frame photographed with main light emission in a light emission amount G0 at a time point t0, and Y1 represents a luminance value in an object area in an image of an immediately preceding frame photographed with main light emission in a light emission amount G1 at a time point t1. Photographing with main light emission is performed with the light emission amount G1 at the time point t1, which has been predicted such that Y1−Y0=0 holds, but there is a case where the moving direction or speed of the object changes after the prediction time point (see FIG. 3A). In this case, if Y1−Y0>Th2 holds, a predicted light amount G2 set for photographing of the next frame becomes an over-light emission amount beyond an error range. On the other hand, if Y1−Y0<Th1 holds, the predicted light emission amount G2 becomes an under-light emission amount beyond the error range.

Therefore, Yd=Log(Y1/Y0) as a difference in brightness of the object between the time point t0 and the time point t1 is set as a deviation amount between the predicted light emission amount G2 and a proper light emission amount G2′,and a prediction result immediately before photographing the next frame is corrected to thereby accurately hold the prediction accuracy thereafter.

Specifically, when the prediction result immediately before photographing the next frame is represented by Rp, G2−G1 can be calculated as 2*Log(Rp) from the equation (2), and hence the prediction result is corrected by the following equation (3) for correcting the proper light emission amount G2′ by Yd as the deviation amount from the predicted light emission amount G2. That is, Rp stored in the memory 108 is replaced by Rp*(Y0/Y1)^{1/2}.

$$\begin{matrix}G 2 ’ - G 1 = ( G 2 - Yd ) - G 1 \\ = ( G 2 - G 1 ) - Yd = 2 * Log ( Rp ) - Yd \\ = 2 * Log ( Rp * {( Y 0 / Y 1 )}^{1 / 2} )\end{matrix} \qquad ( 3 )$$

With the above-described process, even in a case where the accuracy of prediction does not satisfy the predetermined accuracy, it is possible to properly keep the brightness of the object in the next and subsequent photographing operations by correcting the prediction result.

Next, a third embodiment will be described. In the above-described first and second embodiments, when determining the main light emission amount, the LV is lowered in luminance when photographing is performed in the dark, and hence there is a possibility that even when an object is detected from the LV image, high detection accuracy cannot be obtained. Further, in photographing of an object which highly reflects light, there is a possibility that even when an object is detected from a still image, high detection accuracy cannot be obtained due to a reflected light of light emitted from the strobe device 300 and reflected from the object when photographing is performed.

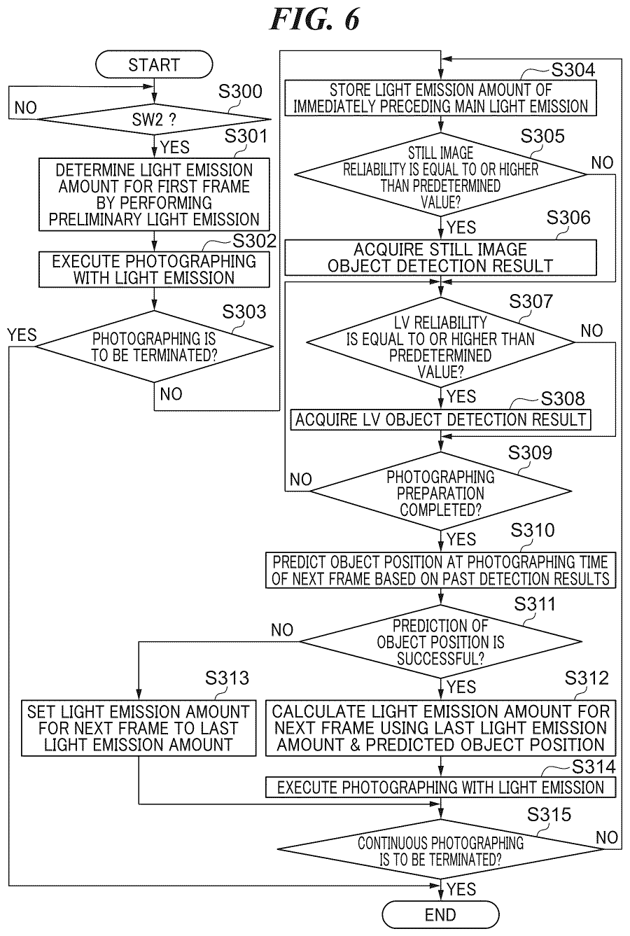

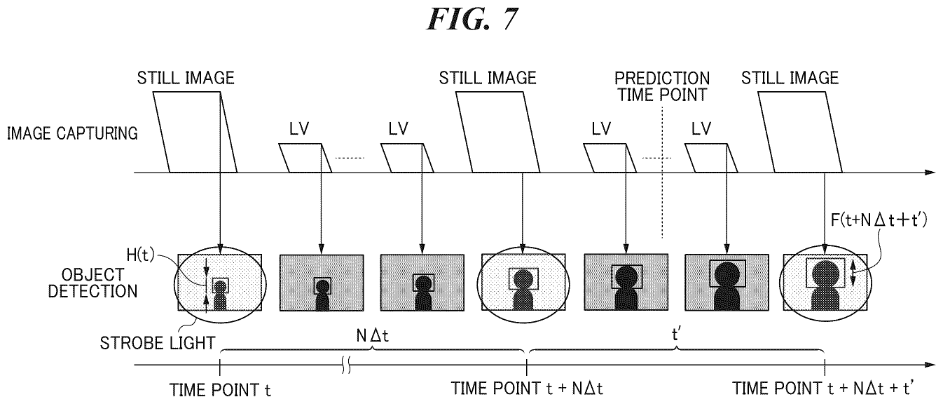

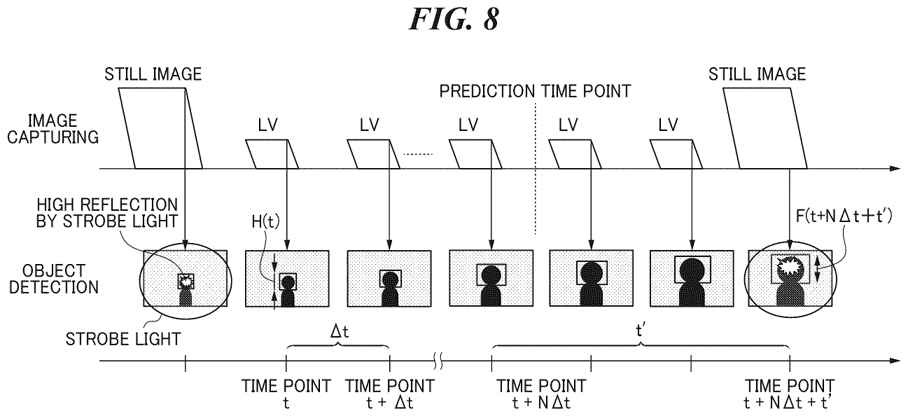

To solve this problem, in the present embodiment, in a case where continuous photographing with strobe is performed with the non-preliminary light emission setting, the main light emission amount for the next frame is determined according to the object detection accuracy in the LV image and the still image, and the next frame is photographed with the proper light emission amount. A control process for continuous photographing without preliminary light emission according to the present embodiment will be described in detail with reference to a flowchart in FIG. 6 and timing diagrams in FIGS. 7 and 8.

Note that in the present embodiment, the same hardware components and software components as those of the first embodiment are denoted by the same reference numerals, and redundant description is omitted.

FIG. 6 is a flowchart of a control process for continuous photographing without preliminary light emission in the present embodiment.

The present process is executed in the camera controller 101 by the CPU 101a that loads a program stored in the ROM 101b into the RAM 101c.

Note that steps S300 to S304, S314, and S315 are the same processing operations as the steps S100 to S104, S110, and S111 of the first embodiment, and hence description thereof is omitted. The following description will be given only of main steps in the control process shown in FIG. 6.

First, after execution of the steps S300 to S304, the camera controller 101 (second judgment unit) proceeds to a step S305 and determines whether or not the still image reliability is equal to or higher than a still image reliability reference value (second threshold value).

Specifically, in the immediately preceding photographing result, the still image reliability is acquired which indicates, as a probability, whether or not an object has been accurately detected, based on a feature amount (such as a shape, a color, and an outline) of an object detected by the object detection unit 110 from the still image.

Next, the still image reliability and the still image reliability reference value for determining whether or not an object detection result can be used are compared. If the still image reliability is equal to or higher than the still image reliability reference value (YES to the step S305), the process proceeds to a step S306, wherein a type, a size, and an orientation of the object detected by the object detection unit 110, and the photographing time are stored in the memory 108 as the still image object detection result, and the process proceeds to a step S307. On the other hand, if the still image reliability is lower than the still image reliability reference value (lower than the second threshold value) (NO to the step S305), the process directly proceeds to the step S307.

Here, for example, in a case where the object includes a reflective object, part of the object image is overexposed by the strobe light, and features of the object, such as a shape and an outline, sometimes becomes unclear, or a color does not accurately appear. In such a case, the still image reliability acquired in the step S305 is lowered.

In the step S307, the camera controller 101 (first judgment unit) controls the image sensor 102 to start LV image capturing using a vertical synchronization signal output after photographing a frame as a trigger. After that, the camera controller 101 determines whether or not the LV reliability is equal to or higher than a LV reliability reference value (equal to or higher than a first threshold value) for each captured LV image.

Specifically, for each captured LV image, from the photographing result, the LV reliability is acquired which indicates, as a probability, whether or not an object has been accurately detected, based on a feature amount (such as a shape, a color, and an outline) of an object, detected by the object detection unit 110, in the LV image.

Next, for each captured LV image, the LV reliability and the LV reliability reference value for determining whether or not an LV object detection result can be used are compared. If the LV reliability is equal to or higher than the LV reliability reference value (YES to the step S307), the process proceeds to a step S308, wherein a type, a size, and an orientation of the object and the photographing time are stored in the memory 108 as the LV object detection result detected from the captured LV image by the object detection unit 110. Thereafter, the process proceeds to a step S309. On the other hand, if the LV reliability is lower than the LV reliability reference value (lower than the first threshold value) (NO to the step S307), the process directly proceeds to the step S309.

Here, in photographing e.g. in a dark environment, the LV is low in luminance, so that there are cases where the feature of the object, such as the shape and the outline, becomes unclear, a color does not accurately appear, and as a result of increasing the ISO sensitivity so as to obtain proper exposure to the LV, image noise is increased. In this case, the LV reliability acquired in the step S307 is lowered.

Note that in the steps S305 and S307, in a case where the answer to the question of the step S303 is negative (NO), to determine whether or not a result of object detection can be used, the still image reliability and the LV reliability are acquired and compared with the respective reliability reference values, but this is not limitative. For example, in a case where the ISO sensitivity is high, the still image reliability and the LV reliability are lowered due to noise and overexposure, and hence the process can be configured to proceed to the step S305 even if the answer to the question of the step S303 is negative (NO) and the ISO sensitivity is lower than a predetermined value. Further, in a case where the luminance value acquired from a still image or LV is a high luminance value, the still image reliability and the LV reliability are lowered due to overexposure, and hence the process can be configured to proceed to the step S305 if the answer to the question of the step S303 is negative (NO), and the luminance value acquired from the still image or the LV is equal to or lower than a predetermined luminance.

In the step S309, the camera controller 101 determines whether or not the photographing preparation is completed. Specifically, for example, in a case where the exposure control values of the camera 1 have been set, and at the same time, a photographing timing of the next frame based on the photographing interval setting of the continuous photographing is reached during a preparation time period of the continuous photographing, it is determined that the photographing preparation is completed.

If it is determined that the photographing preparation is completed (YES to the step S309), the process proceeds to a step S310, whereas if it is determined that the photographing preparation is not completed yet (NO to the step S309), the process proceeds to the step S307.

In the step S310, the camera controller 101 controls the object moving distance prediction unit 111 to predict a moving distance between the object and the camera 1 at a photographing time of the next frame based on a plurality of past detection results and the photographing times, which are stored in the memory 108.

Specifically, a ratio (R) between an object distance at a time point when an immediately preceding frame was photographed and a predicted object distance at a time point when the next frame is to be photographed is calculated, and this ratio (R) is stored in the memory 108 as the prediction result. Further, an object position prediction flag indicating that the object position is predicted is set and stored in the memory 108.

As shown in FIG. 3A, in a case where detection results have been obtained from both of a still image photographed in the immediately preceding frame and an LV image, by using the same method as used in the first embodiment, it is possible to predict a moving distance of the object until the next photographing time point. That is, by setting the photographing time (t) of the still image of the first frame as the start point, and using the number (N) of the LV images output up to the latest time, the interval (Δt) at which each LV is output, and a time period (t′) until the next photographing, it is possible to predict the moving distance of the object until the next photographing time point.

Hereafter, an example in which an object cannot be detected from at least one of a still image photographed in an immediately preceding frame and an LV image will be described with reference to the timing diagrams shown in FIGS. 7 and 8.

FIG. 7 is the timing diagram showing the control of continuous photographing without preliminary light emission in a case where an object cannot be detected from LV images due to a low luminance of the LV images caused e.g. in strobe photographing in the dark. In the case as shown in FIG. 7, in the present embodiment, there are used, by setting a photographing time (t) at which a still image of the first frame was photographed as a start point, still images of N frames output up to the latest time, an interval (Δt) at which each still image is output, and a time period (t′) until the photographing of the next frame. With this, by using the same method as used in the first embodiment, it is possible to predict the moving distance of the object up to the time point when the next frame is to be photographed.

FIG. 8 is the timing diagram useful in explaining the control of continuous photographing without preliminary light emission in a case where an object cannot be detected from a still image due to a high luminance of the still image, caused e.g. by high reflection at and/or around an object when strobe photographing is performed. In the case as shown in FIG. 8, there are used, by setting a photographing time (t) at which a first LV image was photographed as a start point, N LV images output up to the latest time, an interval (Δt) at which each LV image is output, and a time period (t′) from the latest time point until the next photographing. With this, by using the same method as used in the first embodiment, it is possible to predict the moving distance of the object up to the time point when the next frame is to be photographed.

Referring again to FIG. 6, in the step S310, in a case where there is no past detection result, or there is only one detection result, the object position prediction flag is cleared and stored in the memory 108 so as not to perform prediction calculation in post-stage processing.

Note that in the present embodiment, in such a case, as shown in FIG. 7, where the moving distance of the object is predicted using only a detection result obtained from a still image in the step S310, if the continuous photographing interval is long, such as five seconds, since an object can be detected only at an interval of five seconds, there is a possibility that it is difficult to predict the movement of an object, as in a case where the direction of movement of an object changes between frames such that the object is coming toward the near side in the preceding frame but going away in the next frame. For this reason, in a case where only detection results obtained from still images are used, a step S305a (not shown in FIG. 7) for determining whether or not the continuous photographing interval is within a predetermined value can be added between the step S305 and the step S306. That is, the process can be configured such that if the answer to the question of the step S305a is affirmative (YES), the process proceeds to the step S306, whereas if the answer to the question of the step S305a is negative (NO), the process proceeds to the step S307. With this, it is possible to keep the detection accuracy of the still image.

In a step S311, the camera controller 101 determines whether or not prediction of the object position in the next frame has been successfully performed. Specifically, in a case where the object position prediction flag stored in the memory 108 has been set, it is determined that prediction of the object position has been successfully performed (YES to the step S311), and the process proceeds to a step S312. On the other hand, in a case where the object prediction flag has been cleared, it is determined that prediction of the object position in the next frame has not been successfully performed (NO to the step S311), and the process proceeds to a step S313.

In the step S312, the camera controller 101 controls the light emission amount calculation unit 112 to calculate an optimum light emission amount to be set for photographing of the next frame based on the position of the object at a time point when the next frame is to be photographed, which is predicted in the step S310, and the light emission amount used last time. Specifically, in a case where the still image object detection result has been acquired in the step S306, and the LV object detection result has been acquired in the step S308, the light emission amount calculation unit 112 (first determination unit) calculates the main light emission amount for the next frame based on both of the object detection results. Further, in a case where one of the still image object detection result in the step S306 and the LV object detection result in the step S308 has been acquired, the light emission amount calculation unit 112 (second determination unit/third determination unit) calculates the main light emission amount for the next frame based on the acquired one object detection result. After that, the process proceeds to the step S314. Note that the processing operations in the step S314 et seq. are the same as the processing operations in the step S110 et seq. in FIG. 2, and hence description thereof is omitted.

In the step S313, since the object position cannot be predicted, the camera controller 101 (fourth determination unit) sets the light emission amount in photographing of the next frame to the light emission amount in photographing of the preceding frame. At this time, a warning icon indicating that the object position in the next frame cannot be predicted can be displayed on the display unit 106 (warning unit). Thereafter, the process proceeds to the step S314. Note that the processing operations in the step S314 et seq. are the same as the processing operations in the step S110 et seq. in FIG. 2, and hence description thereof is omitted.

With the above-described process, in the continuous photographing with strobe light emission, it is possible to detect an object with high accuracy without performing preliminary light emission between frames. This makes it possible to predict the moving distance of the object with high accuracy and perform photographing with a proper light emission amount.

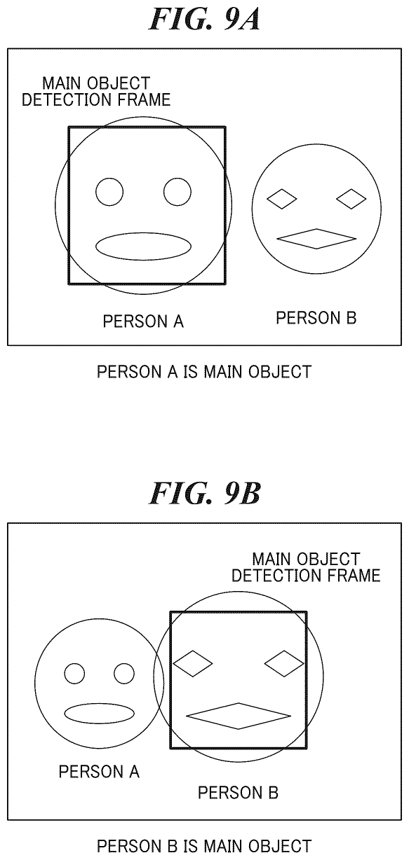

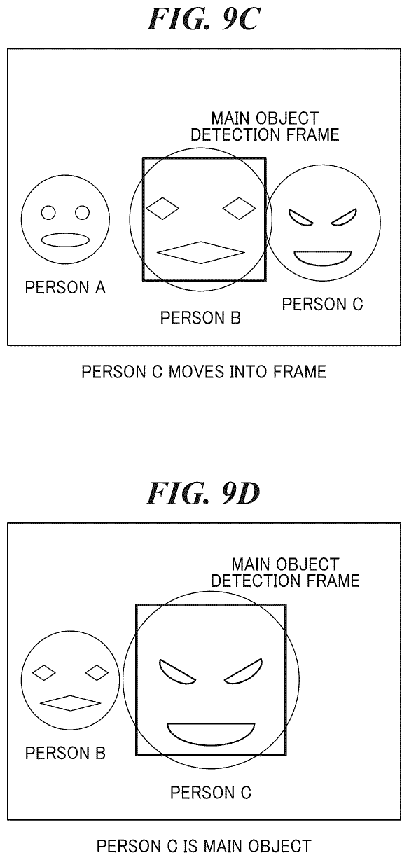

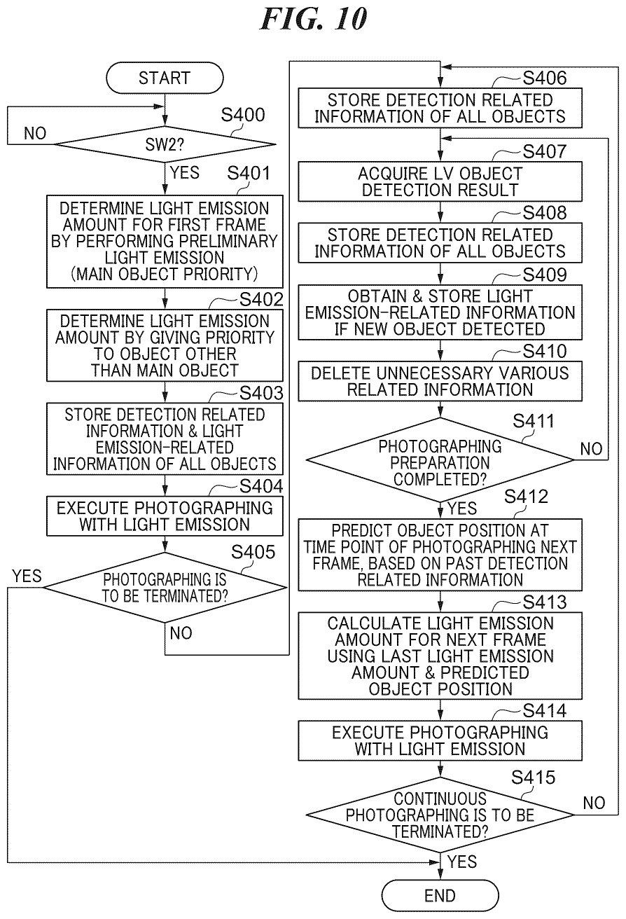

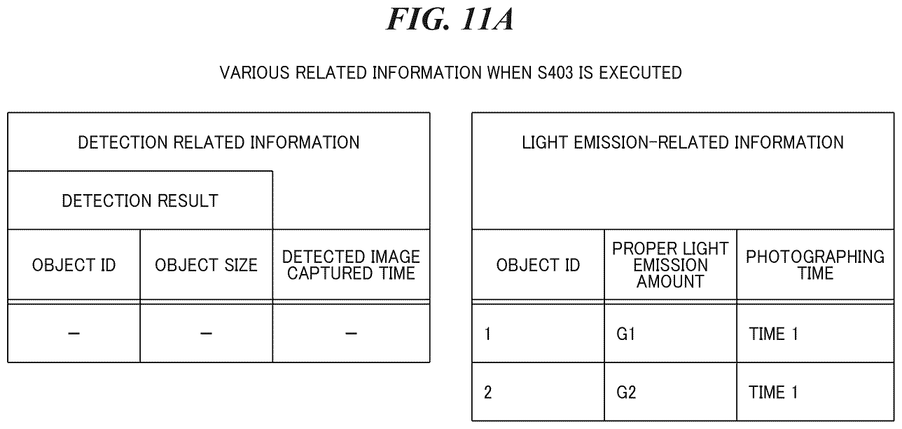

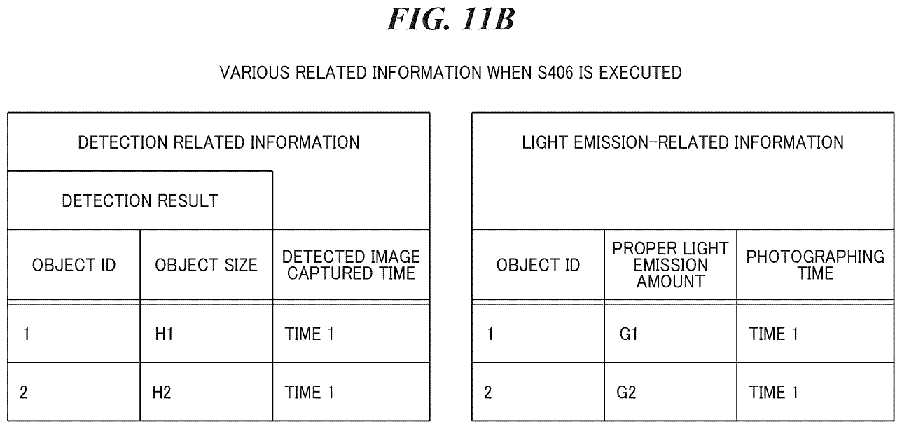

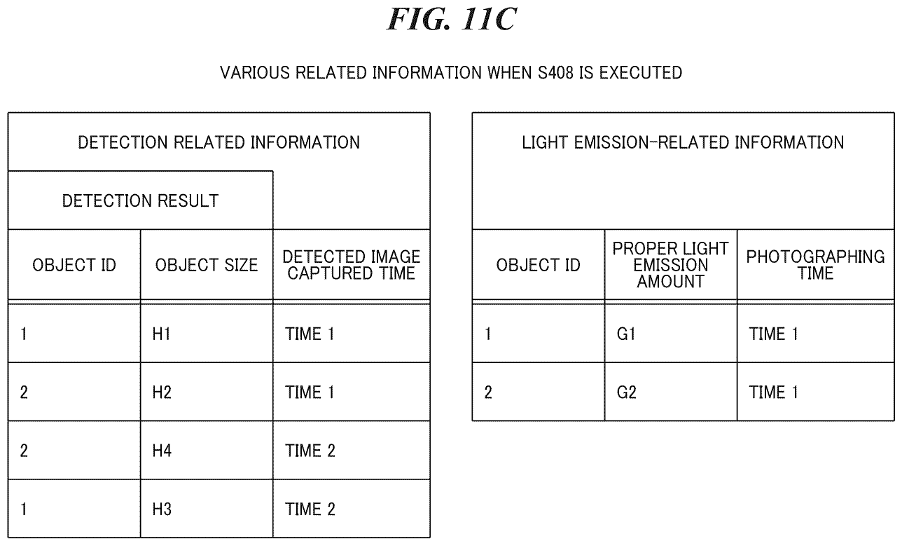

Next, a fourth embodiment will be described. In the above-described first, second, and third embodiments, movement of one object between frames is predicted, and the light emission amount is determined. On the other hand, in the present embodiment, as shown in FIGS. 9A to 9D, movement of an object between frames in a case where a plurality of faces are the objects is predicted, and the light emission amount is determined. A control process for continuous photographing without preliminary light emission according to the present embodiment will be described in detail with reference to examples of object detection states, shown in FIGS. 9A to 9D, a flowchart in FIG. 10, and tables of various related information, shown in FIGS. 11A to 11C.

Note that in the present embodiment, the same hardware components and software components as those of the first embodiment are denoted by the same reference numerals, and redundant description is omitted.

FIGS. 9A to 9D are diagrams useful in explaining the examples of a state in which a plurality of objects are detected in the present embodiment.

FIG. 9A shows a state in which a person A and a person B are the objects, and the person A has been detected as a main object. The main object is determined by the object detection unit 110 (main object determination unit) based on a plurality of criteria, such as a size of the object, and how close the detected position is to the center of the screen, whereby a main object detection frame indicating the main object is set. Note that this set main object detection frame can be displayed by the display unit 106 to present the detection state of the main object to a user.

In the state shown in FIG. 9A, the camera controller 101 performs the light modulation control so as to obtain proper brightness for the person A who is the main object. With this, the person B who is not the main object sometimes is different from the person A who is the main object in the distance from the camera 1 and the reflectivity, and hence the proper brightness cannot be necessarily obtained for the person B but can be obtained for the person A who is the main object.

That is, even in a case where a plurality of objects are detected, the first embodiment can be used insofar as the person A set as the main object first is the main object. That is, it is possible to calculate the light emission amount for the next frame, which is required to obtain the proper brightness for the person A as the main object, and obtain the proper brightness for the main object without performing preliminary light emission during the continuous photographing.

Here, let us consider a case where the main object has been changed to the person B as shown in FIG. 9B. For example, in a case where the person B moves close to the camera 1 or moves close to the center of the screen, the object detection unit 110 switches the main object from the person A to the person B. In the state shown in FIG. 9B, the camera controller 101 performs the light modulation control so as to obtain the proper brightness for the person B as the main object. However, the light emission amount for the next frame, which calculated by the method of the first embodiment, is for making the brightness of the person A proper, and hence it is impossible to obtain the proper brightness for the person B. With the method used in the first embodiment, to obtain the proper brightness for the person B, it is necessary to perform the process from the preliminary light emission in the step S101 again.

To cope with this, in the present embodiment, even in the case where the main object has been changed during the continuous photographing as described above, it is made possible to obtain proper brightness for the main object without performing preliminary light emission. A control process for continuous photographing without preliminary light emission according to the present embodiment will be described in detail below with reference to FIG. 10.

Note that in the present embodiment, the same hardware components and software components as those of the first embodiment are denoted by the same reference numerals, and redundant description is omitted.

FIG. 10 is a flowchart of the control process for continuous photographing without preliminary light emission in the present embodiment.

The present process is executed in the camera controller 101 by the CPU 101a that loads a program stored in the ROM 101b into the RAM 101c.

In a step S400, the camera controller 101 determines whether the current state of the SW2 is ON or OFF. If the current state of the SW2 is OFF (NO to the step S400), the determination in the step S400 is repeated. On the other hand, if the current state of the SW2 is ON (YES to the step S400), the process proceeds to a step S401.

In the step S401, the camera controller 101 performs preliminary light emission by using the strobe device 300 immediately before photographing the first frame and controls the light emission amount calculation unit 112 to calculate a proper light emission amount based on the preliminary illuminated image captured by the image sensor 102. In a case where there are a plurality of objects, the light emission amount calculation unit 112 (proper light emission amount calculation unit) calculates a light emission amount by giving the priority to the main object and obtains the light emission amount which can obtain proper brightness for the main object (hereinafter referred to as the proper light emission amount).

In a step S402, the camera controller 101 controls the light emission amount calculation unit 112 (proper light emission amount calculation unit) to calculate a light emission amount by giving the priority to an object other than the main object based on the preliminary illuminated image acquired in the step S401, on an object-by-object basis, and obtains the proper light emission amount for each object other than the main object.

In a step S403, the camera controller 101 stores detection related information of all objects included in the preliminary illuminated image in the memory 108 (storage unit) based on results of calculations in the steps S401 and S402. Note that a detection result including an object ID and an object size of each object is associated with the detection related information of all objects. Further, after an image capturing operation in a step S404, described hereinafter, a time at which a detection target image is captured by the image sensor 102 (hereinafter referred to as the detection image photographing time) is also registered in this detection related information. Further, in the step S403, with respect to all objects included in the preliminary illuminated image, the object ID of each object, the proper light emission amount of the object corresponding to the object ID, and the next photographing time are stored in the memory 108 (storage unit) in a state associated with each other as light emission-related information. Hereafter, the detection related information and the light emission-related information are referred to as the various related information. An example of the various related information will be described hereinafter with reference to FIGS. 11A to 11C.

In the step S404, the camera controller 101 notifies the strobe device 300 of the light emission amount calculated by the light emission amount calculation unit 112 in the step S401 and the light emission timing via the strobe contact group 109. With this, the camera controller 101 causes the strobe controller 301 to perform main light emission simultaneously with photographing of the first frame. With this, the main object is photographed with proper brightness in the photographed image.

In a step S405, the camera controller 101 determines whether to continue or terminate the photographing. This determination is performed by using the same method as used in the step S103.

If it is determined that the photographing is to be continued (NO to the step S405), the process proceeds to a step S406, wherein processing for photographing the next frame is executed. On the other hand, if it is determined that the photographing is to be terminated (YES to the step S405), the present process is terminated.

In the step S406, the camera controller 101 stores a light emission amount of immediately preceding main light emission, a result of detection of an object detected by the object detection unit 110 from the immediately preceding image capturing result, and an image capturing time (hereinafter referred to as the “detection image capturing time”) in the memory 108, as the detection related information. In a case where a plurality of objects have been detected, the detection related information of all objects including the objects other than the main object are stored. An example of the detection related information of the objects, which are stored, will be described hereinafter with reference to FIGS. 11A to 11C. The immediately preceding photographing result mentioned here refers to the photographing result of the first frame photographed in the step S404. However, in a case where it is determined in a step S415, described hereinafter, that the continuous photographing is to be continued, and the process proceeds to the step S406, the immediately preceding photographing result refers to a photographing result of a frame photographed in a step S414.

In a step S407, the camera controller 101 controls the image sensor 102 to start image capturing of the LV between frames by using a vertical synchronization signal output after photographing a frame as a trigger. Thereafter, for each captured LV image, the camera controller 101 stores a detection result of an object detected from the image capturing result by using the object detection unit 110 and the LV image capturing time in the memory 108 as the LV object detection result.

Then, in a step S408, the camera controller 101 stores the detection related information including the LV detection result acquired in the step S407 in the memory 108. In a case where a plurality of objects have been detected, the pieces of detection related information of all objects including objects other than the main object are stored. An example of the detection related information of the objects, which is stored, will be described hereinafter with reference to FIGS. 11A to 11C.

In a step S409, the camera controller 101 refers to the detection related information stored in the preceding steps S406 and S408, and determines whether or not an object which is different from the object(s) detected so far has been newly detected. Note that the light emission-related information of the newly detected object has not been stored in the memory 108 yet. Therefore, the camera controller 101 controls the light emission amount calculation unit 112 (second proper light emission amount calculation unit) to calculate a proper light emission amount based on the photographed image of the immediately preceding frame and the LV images obtained after the photographed image. For example, a case will be described, by way of example, where in a state in which only the person A and the person B have been detected in the first frame as shown in FIG. 9A, a person C has moved into the frame in the second frame as shown in FIG. 9C, and the person C has become the main object in the third frame as shown in FIG. 9D. Since the person C is not present in the first frame, a proper light emission amount for the person C cannot be calculated from the preliminary illuminated image and stored in the steps S402 and S403. Therefore, it is impossible to refer to the proper light emission amount for the person C in a step S413, described hereinafter, and obtain a light emission amount which makes proper the brightness for the person C. In this case, in the step S409, the proper light emission amount for the person C is calculated based on the photographed image of the second frame and the LV images between the second frame and the third frame. First, in a case where a detection result of the person C is included in the LV object detection result stored in the step S407, the LV image as the original image of the detection result is acquired as a non-illuminated image of the person C. Further, in a case where a detection result of the person C is included in the detection related information stored in the step S406, the photographed image as the original image of the detection result is acquired as an illuminated image of the person C. In the step S409, the proper light emission amount for the person C is calculated from the non-illuminated image and the illuminated image of the person C, which are acquired as described above, and the calculated proper light emission amount for the person C is stored in the memory 108. With this, in a case where the person C as the new object has moved into the frame in the second frame, it is possible to refer to the proper light emission amount for the person C from the next third frame in the step S413, described hereinafter, and it is possible to calculate the light emission amount which makes proper the brightness for the person C.

In a step S410, the camera controller 101 deletes unnecessary information from the various related information stored in the memory 108. For example, as the various related information stored in the memory 108, if all various related information is left stored with respect to the objects which have been once detected, the free space of the memory 108 is suppressed, and further, it takes time to search for necessary various related information. In view of this, the various related information of an object which has been no longer detected is deleted from the memory 108.

On the other hand, with respect to an object once detected, if the various related information of this object is left stored in the memory 108 for a long time period, even when the object has moved out of the frame in one photographed frame and then moves into the frame in a photographed frame after that, this object can be detected with high accuracy. For example, there is a case where the person A detected in FIGS. 9A to 9C moves out of the frame as shown in FIG. 9D and then moves into the frame again. In this case, if the various related information of the person A remains in the memory 108, the camera controller 101 can quickly calculate the proper light emission amount for the person A by using the light emission amount calculation unit 112 (third proper light emission amount calculation unit). In view of this, let it be assumed that not all various related information of objects which has been no longer detected are deleted from the memory 108, but the various related information for an object which can be authenticated by an object authentication unit (authentication unit), not shown, included in the object detection unit 110 is left stored without being deleted at this time. The object which can be authenticated, mentioned here, means an object which can be identified as an identical object out of a plurality of objects between images. With this, the object which can be authenticated by the object authentication unit can be identified, immediately after this object returns into the screen, as the object which was present in a past frame. On the other hand, with respect to an object which cannot be authenticated by the object authentication unit, even if this object is an object which was present in a past frame, the camera controller 101 cannot recognize this fact, and the past information cannot be used. Therefore, the various related information of such an object is deleted from the memory 108 after this object moves out of the frame. Here, the object which can be authenticated by the object authentication unit can be registered by a user, using the camera operation unit 105, or a specific object can be internally registered by the object detection unit 110 as an object to be authenticated, as part of the detection processing (such as object tracking processing). With this, it is possible to increase the possibility that proper brightness can be obtained for an object which moves into/out of the frame while preventing suppression of the memory 108 and reduction of the searching speed.

In a step S411, the camera controller 101 determines whether or not the photographing preparation is completed. Specifically, in a case where setting of the exposure control values of the camera 1 is completed, and at the same time, the setting of image capturing for a timing of photographing the next frame based on the photographing interval setting of the continuous photographing is completed, it is determined that the photographing preparation is completed.

If the photographing preparation is completed (YES to the step S411), the process proceeds to a step S412, whereas if the photographing preparation is not completed (NO to the step S411), the process returns to the processing for acquiring the LV object detection result in the step S407.

In the step S412, the camera controller 101 controls the object moving distance prediction unit 111 to predict a moving distance between the object and the camera 1 at a time point when the next frame is to be photographed, based on a plurality of past object detection results and the time points when the images have been captured, which are stored in the memory 108. After that, the camera controller 101 calculates a ratio (R) between the object distance at a time point when the immediately preceding frame was photographed and the predicted object distance at the time point when the next frame is to be photographed, and stores the ratio (R) in the memory 108 as the prediction result. Particularly, in a case where there are a plurality of objects, a ratio (R) with respect to the main object is calculated as the prediction result by referring to the detection related information having the same object ID as the object ID included in the detection result of the main object. This example will be described hereinafter with reference to FIGS. 11A to 11C.

In the step S413, the camera controller 101 calculates, using the light emission amount calculation unit 112, the optimum light emission amount for the next frame to be photographed, based on the prediction result calculated in the step S412 and the proper light emission amount associated with the same object ID as the object ID of the main object, which have been stored in the memory 108. By searching for the light emission-related information by using the object ID and the past photographing time used for prediction in the step S412 as a key, the proper light emission amount for the object at the past photographing time can be known. Therefore, by using the predicted distance ratio, it is possible to determine a light emission amount which makes proper the brightness of the object at the next photographing. Note that although the prediction processing in the step S412 and the light emission amount calculation processing in the step S413 can be executed only with respect to the main object, the processing operations can be executed with respect to all objects of which the various related information has been stored in the memory 108, and the calculated light emission-related information can be stored in the memory 108. By updating the light emission-related information here, it becomes unnecessary to always use the light emission-related information of the first frame, which was stored in the step S403, for prediction.

Here, the example of prediction using the light emission-related information stored in the memory 108 will be described with reference to FIGS. 11A to 11C. For example, let it be assumed that an object having an object ID of 1 and an object having an object ID of 2 are detected at a time point when the first frame is photographed, and the object having the object ID of 1 is the main object. At this time, in the step S403, for example, two pieces of light emission-related information of {the object ID=1, the proper light emission amount=G1, the photographing time=time 1} and {the object ID=2, the proper light emission amount=G2, the photographing time=time 1} are stored. The time 1 indicates a time at which the first frame is photographed. The various related information stored in the memory 108 at this time point is as shown in FIG. 11A. In the various related information shown in FIG. 11A, the detection related information does not exist yet, but only the light emission-related information at the time 1 exists. Further, in the step S406, for example, two pieces of detection related information of {the object ID=1, the object size=H1, the detection image photographing time=time 1} and {the object ID=2, the object size=H2, the detection image photographing time=time 1} are stored. In the various related information at this time point, the detection related information at the time 1 as shown in FIG. 11B is added. After that, when the main object is changed in the step S408, here, for example, two pieces of detection related information of {the object ID=2, the object size=H4, the detection image photographing time=time 2} and {the object ID=1, the object size=H3, the detection image photographing time=time 2} are stored. The time 2 is a time at which an LV image is photographed. The various related information at this time point is shown in FIG. 11C. The detection related information at the time 2 is added.

In the step S413, for the light emission amount calculation unit 112 to determine a light emission amount which makes proper in the second frame, the brightness of the object having the object ID=2, which was not the main object in the first frame, it is only required to use the following method: First, a distance ratio of the object having the object ID=2 between the photographing time of the first frame and the photographing time of the second frame is calculated. It is known from the light emission-related information (see FIG. 11C) stored in the memory 108 that the object having the object ID=2 has the size H2 at the time 1and has the size H4 at the time 2, and hence the size (=H6) at the photographing time of the second frame can be predicted by using e.g. a linear approximation formula. Therefore, the distance ratio can be predicted as H6/H2. On the other hand, it is known from the detection related information (see FIG. 11C) stored in the memory 108 that the proper light emission amount for the object having the object ID=2 at the time 1 (=the photographing time of the first frame) is G2.Therefore, it is also possible to calculate the proper light emission amount in the second frame with respect to the object having the object ID=2, based on the proper light emission amount G2, the distance ratio H6/H2, and the equation (2).

Referring again to FIG. 10, in the step S414, the camera controller 101 notifies the strobe device 300 of the light emission amount calculated in the step S413 and the light emission timing via the strobe contact group 109 and causes the strobe controller 301 to perform main light emission simultaneously with photographing of the next frame.

In the step S415, the camera controller 101 determines whether to continue or terminate the continuous photographing. Specifically, in a case where the current state of the SW2 has been changed from ON to OFF, i.e. in a case where the operation of fully pressing the release button has been released by the user, the camera controller 101 determines that the photographing is to be terminated. On the other hand, in a case where the current state of the SW2 has not been changed from ON, i.e. in a case where the operation of fully pressing the release button has been continued by the user, the camera controller 101 determines that the photographing is to be continued.

If it is determined that the photographing is to be continued (NO to the step S415), the step S406 et seq. are repeated. On the other hand, if it is determined that the photographing is to be terminated (YES to the step S415), the present process is terminated.

As described above, in the present embodiment, the proper light emission amount is stored in the memory 108 with respect to all objects detected by the object detection unit 110, in the step S403. With this, even when the main object is changed to another object in the detection result acquired in the step S407, it is possible to calculate a light emission amount which makes proper the brightness of the new main object in the step S413.

When explaining this with reference to the example shown in FIG. 9A to 9D, in the present embodiment, the proper light emission amount is determined and stored also with respect to an object which is not the main object but has been detected as an object at a time point when the step S401 has been executed (steps S402 and S403). With this, it is possible to calculate a light emission amount which makes proper the brightness of the new main object in the step S413. Thus, even in the case where the main object is changed during continuous photographing, it is possible to continuously photograph the main object with proper brightness without performing preliminary light emission as performed for the first frame.

According to the present disclosure, it is possible to perform the light modulation control while following an object with high accuracy without performing preliminary light emission when each frame is photographed immediately after continuous photographing using light emission from a light emitting device is started.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-004685, filed Jan. 14, 2025, which is hereby incorporated by reference herein in its entirety.

What is claimed is:

1. An image capturing apparatus that determines a light emission amount of a light emitting device, and acquires still images by performing continuous photographing with light emission from the light emitting device, including:
at least one processor; and
a memory storing instructions that, when executed by the at least one processor, causes the at least one processor to function as:
a first light emission amount determination unit configured to determine a light emission amount for a first frame of still images that are acquired by the continuous photographing by performing preliminary light emission;
a detection unit configured to detect an object from an image;
a prediction unit configured to predict a moving distance of the object from a time point when a past frame out of the still images that are acquired by the continuous photographing was photographed to a time point when the next frame is to be photographed, based on a detection result obtained by the detection unit; and
a second light emission amount determination unit configured to determine a light emission amount for photographing of the next frame, based on the moving distance of the object, predicted by the prediction unit, and a light emission amount used at the time point when the past frame was photographed.

2. The image capturing apparatus according to claim 1, wherein the detection result includes information indicating a size of the object and a distance between the image capturing apparatus and the object.

3. The image capturing apparatus according to claim 1, wherein the prediction unit predicts the moving distance of the object based on a ratio of a changed amount of the distance between the object and the image capturing apparatus.

4. The image capturing apparatus according to claim 1, wherein the at least one processor is further caused to function as an acquisition unit configured to acquire LV images between frames from a time point when an immediately preceding frame of the still images that are acquired by the continuous photographing was photographed to a time point when the next frame is to be photographed,
wherein the detection unit detects the object from the still image of the immediately preceding frame and the LV images between the frames as the image, and
wherein the prediction unit predicts the moving distance of the object based on results of object detection from the still image of the immediately preceding frame and the LV images between the frames, which are continuous on a time-series basis.

5. The image capturing apparatus according to claim 4, wherein in a case where it is determined that a prediction result of the moving distance of the object, predicted with respect to the immediately preceding frame, does not satisfy a predetermined accuracy, the prediction unit corrects a prediction result of the moving distance of the object, predicted with respect to the next frame.

6. The image capturing apparatus according to claim 5, wherein in a case where a difference between brightness of the still image of the first frame and brightness of a photographing result of the still image of the immediately preceding frame is not within a predetermined range, the prediction unit determines that the prediction result does not satisfy the predetermined accuracy.

7. The image capturing apparatus according to claim 6, wherein the detection unit includes information which identifies an object area, and
wherein the brightness of the still image is calculated from luminance values of blocks belonging to the object area.

8. The image capturing apparatus according to claim 4, wherein the second light emission amount determination unit includes:
a first judgment unit configured to determine whether or not LV reliability at a time when an object is detected from the LV images between the frames is equal to or higher than a first threshold value,
a second judgment unit configured to determine whether or not still image reliability at a time when an object is detected from the still image of the immediately preceding frame is equal to or higher than a second threshold value,
a first determination unit configured to determine, in a case where the LV reliability is equal to or higher than the first threshold value, and at the same time, the still image reliability is equal to or higher than the second threshold value, a main light emission amount for the next frame based on both of detection results of object detection from the LV images between the frames and object detection from the still image of the immediately preceding frame,
a second determination unit configured to determine, in a case where the LV reliability is equal to or higher than the first threshold value, but the still image reliability is lower than the second threshold value, a main light emission amount for the next frame based only on the detection result of object detection from the LV images between the frames,
a third determination unit configured to determine, in a case where the LV reliability is lower than the first threshold value, but the still image reliability is equal to or higher than the second threshold value, a main light emission amount for the next frame based only on the detection result of object detection from the still image of the immediately preceding frame, and
a fourth determination unit configured to determine, in a case where the LV reliability is lower than the first threshold value, and at the same time, the still image reliability is lower than the second threshold value, a main light emission amount for the next frame, using only a light emission amount used in past photographing.

9. The image capturing apparatus according to claim 8, wherein the at least one processor is further caused to function as a warning unit configured to provide, in a case where the main light emission amount is determined by the fourth determination unit, a warning to the effect that an object position in the next frame cannot be predicted.

10. The image capturing apparatus according to claim 8, wherein in a case where the main light emission amount is determined by the third determination unit, the second light emission amount determination unit sets a continuous photographing interval of a still image within a predetermined value.

11. The image capturing apparatus according to claim 8, wherein the LV reliability and the still image reliability are determined based on at least one of feature amounts of a shape, a color, and an outline of a detected object.

12. The image capturing apparatus according to claim 8, wherein the accuracy of the LV reliability and the still image reliability is calculated in a case where the ISO sensitivity is equal to or lower than a predetermined value.

13. The image capturing apparatus according to claim 8, wherein the accuracy of the LV reliability and the still image reliability is calculated in a case where the luminance values acquired from the LV images and the still image are equal to or lower than a predetermined luminance value.

14. The image capturing apparatus according to claim 1, wherein the at least one processor is further caused to function as:
a main object determination unit configured to determine, in a case where the detection unit has detected a plurality of objects from the image, one of the plurality of objects as a main object according to a criterion set in advance,
a proper light emission amount calculation unit configured to calculate a light emission amount for making proper the brightness of each of the plurality of objects, on an object-by-object basis, and
a storage unit configured to store and hold a detection result for predicting the moving distance and a light emission amount calculated by the proper light emission amount calculation unit in a state associated with each other for each of the plurality of objects, and
wherein the second light emission amount determination unit
searches, in a case where the main object determination unit changes the main object from one object of the plurality of objects to another object during the continuous photographing, the storage unit for the detection result and the light emission amount of the changed new main object, and
determines a light emission amount for photographing of the next frame based on a result of the search.

15. The image capturing apparatus according to claim 14, wherein the proper light emission amount calculation unit performs calculation at a timing when the first light emission amount determination unit determines a light emission amount.

16. The image capturing apparatus according to claim 14, wherein the at least one processor is further caused to function as a second proper light emission amount calculation unit configured to calculate, in a case where the detection unit has detected an object different from objects which have been detected during the continuous photographing, a light emission amount for making proper the brightness for this different object, and
wherein the storage unit stores the different object, a light emission amount calculated by the second proper light emission amount calculation unit, and a detection result for predicting the moving distance in a state associated with each other.

17. The image capturing apparatus according to claim 16, wherein in a case where the detection unit has detected the different object from a still image of an immediately preceding frame out of still images that are acquired by the continuous photographing, the second proper light emission amount calculation unit calculates the calculated light emission amount based on the still image of the immediately preceding frame and the LV images between frames from a time point when the immediately preceding frame was photographed to a time point when the next frame is to be photographed.

18. The image capturing apparatus according to claim 14, wherein the at least one processor is further caused to function as:
an authentication unit configured to authenticate an object which can be identified, out of the plurality of objects, as the same object, between images, and
a third proper light emission amount calculation unit configured to calculates, in a case where the object which can be identified is released from a state authenticated by the authentication unit and then returns to the authenticated state, during the continuous photographing, a light emission amount for obtaining proper brightness of the object which has returned to the authenticated state, based on the light emission amount associated with the object which has returned to the authenticated state and a detection result for predicting the moving distance, which are stored in the storage unit.

19. The image capturing apparatus according to claim 18, wherein the storage unit holds a detection result for predicting the object moving distance and a light emission amount for making brightness proper, with respect to at least all of the objects which can be identified, in a state associated with each other during the continuous photographing.

20. The image capturing apparatus according to claim 18, wherein the storage unit deletes a detection result for predicting the moving distance and a light emission amount for making brightness proper, with respect to an object other than the objects which can be identified, out of the plurality of objects, from the storage unit when this object is no longer detected by the detection unit.

21. A method of controlling an image capturing apparatus that determines a light emission amount of a light emitting device, and performs continuous photographing of still images with light emission from the light emitting device, comprising:
determining a light emission amount for a first frame of still images acquired by the continuous photographing by performing preliminary light emission;
detecting an object from an image;
predicting a moving distance of the object from a time point when a past frame out of the still images that are acquired by the continuous photographing was photographed to a time point when the next frame is to be photographed, based on a detection result obtained by the detecting; and
determining a light emission amount for photographing of the next frame, based on the moving distance of the object, predicted by the predicting, and a light emission amount used at the time point when the past frame was photographed.

22. A non-transitory computer-readable storage medium storing a program for causing a computer to execute a method of controlling an image capturing apparatus that determines a light emission amount of a light emitting device, and performs continuous photographing of still images with light emission from the light emitting device, comprising:
determining a light emission amount for a first frame of still images acquired by the continuous photographing by performing preliminary light emission;
detecting an object from an image;
predicting a moving distance of the object from a time point when a past frame out of the still images that are acquired by the continuous photographing was photographed to a time point when the next frame is to be photographed, based on a detection result obtained by the detecting; and
determining a light emission amount for photographing of the next frame, based on the moving distance of the object, predicted by the predicting, and a light emission amount used at the time point when the past frame was photographed.
